(19) United States
(12) Patent Application Publication
(10) Pub. No.: US 2013/0291539 A1
(43) Pub. Date: Nov. 7, 2013

(54) EXHAUST-GAS TURBOCHARGER HAVING A COMPRESSOR HOUSING WITH AN INTEGRATED WASTEGATE ACTUATOR

(71) Applicants: Achim Koch, Tegernheim (DE); Christian Uhlig, Worms (DE); Roland Herfurth, Regensburg (DE); Christoph Sparrer, Regensburg (DE); Martin Lasar, Bad Soden (DE); Vinzent Kremina, Frankfurt (DE); Thorsten Eid, Limburg-Eschhofen (DE)

(72) Inventors: Achim Koch, Tegernheim (DE); Christian Uhlig, Worms (DE); Roland Herfurth, Regensburg (DE); Christoph Sparrer, Regensburg (DE); Martin Lasar, Bad Soden (DE); Vinzent Kremina, Frankfurt (DE); Thorsten Eid, Limburg-Eschhofen (DE)

(73) Assignee: CONTINENTAL AUTOMOTIVE GMBH, Hannover (DE)

(21) Appl. No.: 13/979,687

(22) PCT Filed: Jan. 9, 2012
(86) PCT No.: PCT/EP2012/050226

§ 371 Date: Jul. 15, 2013

(30) Foreign Application Priority Data
Jan. 13, 2011 (DE) 10 2011 002 627.4

(51) Int. Cl. F02B 37/18

(52) U.S. Cl. CPC F02B 37/183
USPC 60/602

(57) ABSTRACT

An exhaust gas turbocharger has a compressor housing formed with a fresh-air inlet duct. An electric wastegate actuator is integrated into the compressor housing. The electric wastegate actuator is thermally coupled to the fresh-air inlet duct.

The invention relates to an exhaust-gas turbocharger which is equipped with a so-called wastegate.

Exhaust-gas turbochargers serve for improving the efficiency of an internal combustion engine and thus increasing the power thereof. For this purpose, the exhaust-gas turbocharger has a turbine with a turbine wheel and a compressor with a compressor wheel, wherein the two rotor wheels are arranged on a common shaft. Here, the turbine wheel is driven by means of an exhaust-gas mass flow from a connected internal combustion engine, and in turn, drives the compressor wheel. The compressor compresses inducted fresh air and conducts said fresh air to the internal combustion engine. The common shaft is mounted in a bearing housing of the turbocharger. Furthermore, the turbine wheel of the turbine is arranged in a turbine housing, and the compressor wheel of the compressor is arranged in a compressor housing.

An exhaust-gas turbocharger of said type has to meet a wide variety of demands during operation on the internal combustion engine or on an engine connected thereto. One of said demands consists in absorbing the high temperatures that can arise for example owing to the hot exhaust-gas mass flow in the turbocharger housing.

Here, the conventional design of an exhaust-gas turbocharger provides individual housings which are composed in each case of a material adapted to the temperature prevailing therein. Here, the compressor housing is normally composed of aluminum, whereas the bearing housing is composed of cast iron, wherein the bearing housing may additionally be designed to be water-cooled. The turbine housing is generally composed, owing to the high temperatures that prevail in said region, of materials with a high nickel content. Owing to the adapted, different materials for the individual housings, said housings are formed as separate parts which are connected to one another, and which in the process must also be sealed off with respect to one another.

The further the engine rotational speed increases, the faster is the rotation of the turbine wheel of the turbine, and with the latter the shaft of the exhaust-gas turbocharger on which the compressor wheel of the compressor is also situated, owing to the driving exhaust-gas flow. As a result of the faster rotation of the shaft and thus also of the compressor wheel, the air delivery rate of the compressor increases. This leads to an increasing exhaust-gas flow from the engine, which in turn leads to the turbine wheel being driven faster. So as not to exceed the respectively defined mechanical and thermal limits of the engine, regulation of the exhaust-gas turbocharger is necessary.

Such regulation of an exhaust-gas turbocharger may be realized using a wastegate, also referred to as a bypass valve. Such a wastegate has a flap which is connected to the turbine housing of the exhaust-gas turbocharger and which can be opened as required in order, as a function of the open position of the flap, to conduct a greater or lesser part of the hot exhaust gas past the turbine directly into the exhaust system of the vehicle. A further increase of the turbine rotational speed is thereby prevented.

Such a wastegate is subject to high thermal and mechanical loading owing to its position in the hot exhaust-gas flow.

It is already known for wastegate flaps to be adjusted using a pneumatic actuator. Such pneumatic actuators are often also referred to as pressure capsules.

In more recent applications, increasing efforts are now being made to replace the stated pneumatic actuators with electric actuators. Such an electric wastegate actuator offers advantages in relation to a pneumatic wastegate actuator. These advantages include a high actuation speed, good actuation accuracy and high actuation forces. Owing to said high actuation forces, fast closing of the wastegate flap in the associated flap seat is ensured. An electric wastegate actuator however also has disadvantages. These include an increased weight, an increased installation space requirement and self-heating. In particular, the thermal configuration of an electric wastegate actuator poses problems in practice. Temperatures of up to 140° C. prevail in the engine bay of a motor vehicle. Temperatures far higher than this may prevail in the direct vicinity of an exhaust-gas turbocharger. An electric wastegate actuator is additionally heated during the operation thereof by the current flowing through. Under adverse ambient conditions, in particular in the case of high temperatures and a small incident flow, the performance of the actuating element can be reduced. Failure of the wastegate system may even occur. A further challenge in the case of the use of an electric wastegate actuator is posed by the increased demands on the connection between the wastegate actuator and the wastegate flap owing to the greater actuation forces. If said connection is not designed to be adequately stable, an undesired deformation of force-transmitting components may occur. Said undesired deformation of force-transmitting components may also result in failure of the wastegate system.

A further problem that arises in practice is the positioning of the respective wastegate actuator. In general, the wastegate forms a part of the turbine housing. The wastegate actuator or actuator is, by contrast, generally fastened to the compressor housing or to a bracket on the compressor housing. Said bracket is either a separate component, which is fastened to the compressor housing for example by means of screws, or is a component which is produced together with the compressor housing already during the casting process. Said integration of the wastegate actuator into the compressor housing is motivated primarily by cost advantages and packaging advantages.

The bearing housing is arranged between the turbine housing and the compressor housing. Consequently, in the case of known exhaust-gas turbochargers, the wastegate actuator and the wastegate itself are connected to one another by a relatively long tolerance chain.

An electric wastegate actuator must be of correspondingly strong configuration such that it can impart the required actuation forces even when it itself is very hot, and such that it can withstand the occurring load cycles without overheating. Furthermore, during assembly, in a final assembly step, the summed tolerances must be compensated by means of a suitable compensation device in the coupling element or by means of a suitable assembly process of the coupling element. This is associated with considerable outlay and thus also with considerable costs.

DE 10 2007 017 825 A1 has already disclosed a compressor housing for a compressor of a turbocharger, which compressor housing has a receiving region for receiving at least parts of an actuator. Said receiving region may be provided on a cover of the compressor housing or within the compressor housing.

In the case of all known proposals for the positioning of an electric wastegate actuator in an exhaust-gas turbocharger, there is the problem that overheating of the direct-current motor of the electric wastegate actuator may occur.

It is the object of the invention to specify an exhaust-gas turbocharger which is equipped with an electric wastegate actuator and in which the probability of overheating of the direct-current motor of the electric wastegate actuator is reduced.

Said object is achieved by means of an exhaust-gas turbocharger having the features specified in claim 1. The dependent claims specify advantageous embodiments and refinements of the invention.

The advantages of the invention consist in particular in that the electric wastegate actuator of the exhaust-gas turbocharger is integrated into the compressor housing in such a way that, firstly, the heat dissipation from the direct-current motor of the wastegate actuator to the environment is improved, and that, furthermore, a space-saving arrangement of the components of the wastegate actuator in the compressor housing is ensured.

Furthermore, in an exhaust-gas turbocharger according to the invention, all of the force-transmitting components of the wastegate actuator, in particular the direct-current motor, the gearing and the drive output shaft, are connected directly to the compressor housing. This further reduces the probability of heat-induced damage to said components, or a heat-induced failure of the wastegate system.

Said advantages are attained substantially in that the electric wastegate actuator is integrated into the compressor housing in such a way that there is intense thermal coupling between the direct-current motor and the fresh-air inlet duct of the compressor housing. Improved heat dissipation is attained in this way because cold fresh air flows through said region of the compressor housing constantly during operation. This reduces the demands on the components of the electric wastegate actuator, whereby the wastegate system as a whole can be dimensioned so as to be smaller and correspondingly more cost-effective.

Further advantages with regard to packaging and the force flow are attained by means of optimized positioning and improved dimensioning of the further components of the electric wastegate actuator in the compressor housing.

An exhaust-gas turbocharger according to the present invention will be explained by way of example below on the basis of the drawings, in which:

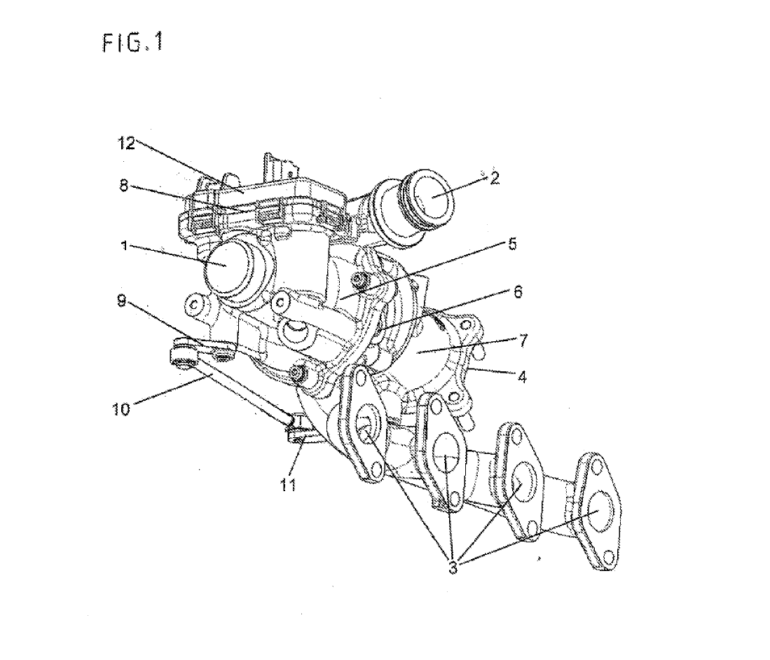

FIG. 1 is a perspective sketch of an exhaust-gas turbocharger having an electric wastegate actuator integrated into the compressor housing,

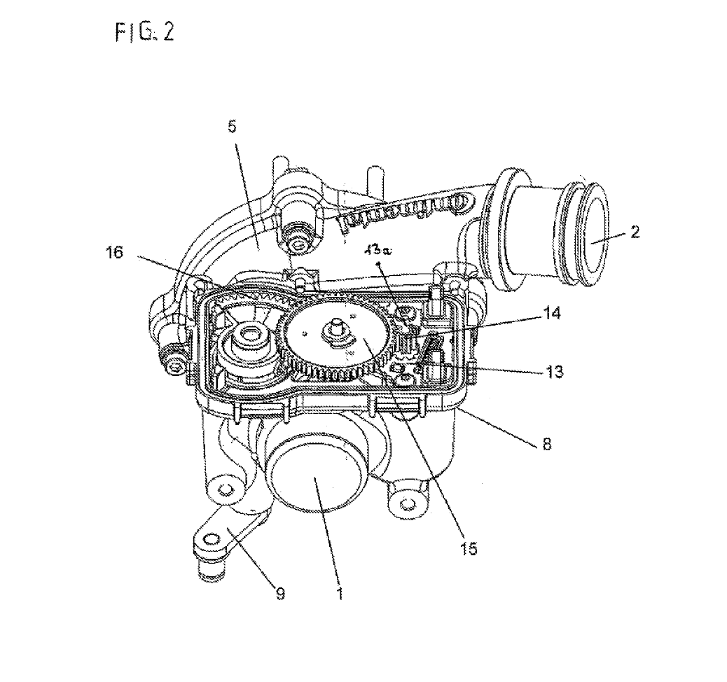

FIG. 2 is a perspective sketch of the compressor housing with an integrated electric wastegate actuator as an assembly, and

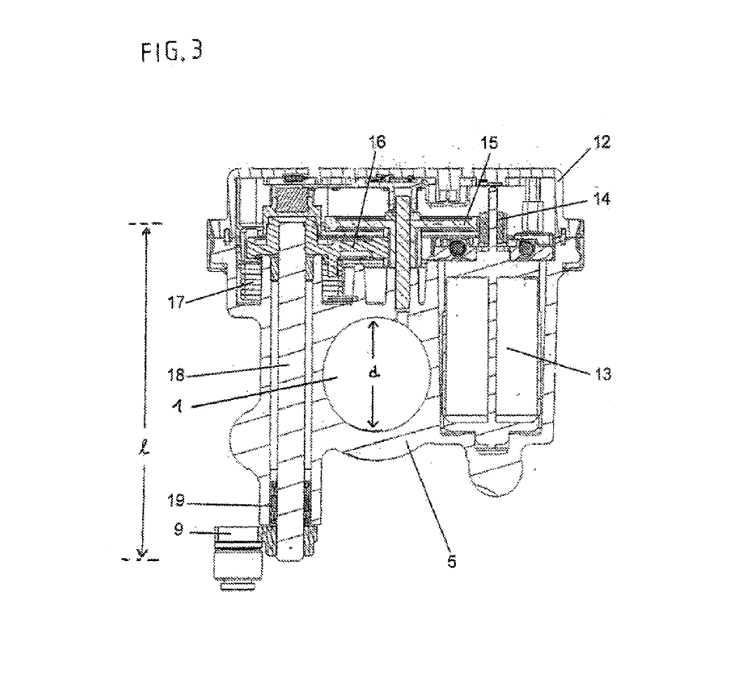

FIG. 3 is a cross-sectional illustration of the compressor housing with an integrated electric wastegate actuator.

An exhaust-gas turbocharger according to the invention comprises a compressor housing having a fresh-air inlet duct and comprises an electric wastegate actuator which is integrated into the compressor housing, wherein the electric wastegate actuator is thermally coupled to the fresh-air inlet duct.

FIG. 1 shows a perspective sketch illustrating an exhaust-gas turbocharger of said type, wherein said illustration shows a view of the outside of the exhaust-gas turbocharger.

The illustrated exhaust-gas turbocharger has a compressor housing 5, a bearing housing 6 and a turbine housing 7.

In the compressor housing 5, in the conventional manner, a compressor wheel is arranged on a common shaft. In the turbine housing 7, in a conventional manner, a turbine wheel is arranged on the common shaft. The common shaft is mounted in the bearing housing 6, which is positioned between the compressor housing 5 and the turbine housing 7. During the operation of the exhaust-gas turbocharger, the turbine wheel is driven by an exhaust-gas mass flow from a connected internal combustion engine, and in turn drives the compressor wheel via the common shaft. The compressor compresses inducted fresh air and conducts said fresh air to the internal combustion engine.

The compressor housing 5 has a fresh-air inlet duct 1, through which fresh air from the environment is inducted into the exhaust-gas turbocharger, and a fresh air outlet duct 2, through which compressed fresh air is discharged in order to be conducted onward to the internal combustion engine.

Furthermore, the compressor housing 5 has an integrated wastegate actuator 8. Said wastegate actuator 8 acts, via a drive output lever 9 and a coupling rod 10, on a wastegate lever 11 which, in accordance with the present demand, opens or closes to a greater or lesser extent a wastegate flap arranged in the turbine housing 7. To permit simple assembly of the components of the electric wastegate actuator 8 in the compressor housing 5, the compressor housing is designed so as to be open in the upward direction, and after the stated assembly is closed off by means of a plastics cover 12.

The bearing housing 6 has an oil inlet (not illustrated) and an oil outlet (likewise not illustrated). Oil which is used for the lubrication of the common shaft enters through the oil inlet during the operation of the exhaust-gas turbocharger.

The turbine housing 7 has exhaust-gas inlet ducts 3 and an exhaust-gas outlet duct 4. The exhaust-gas inlet ducts 3 are connected to exhaust-gas exits of the internal combustion engine, such that the hot exhaust gas of the internal combustion engine passes through the exhaust-gas inlet ducts 3 into the interior region of the turbine housing 7. There, the hot exhaust gas drives the turbine wheel arranged in the turbine housing, which turbine wheel in turn, via the common shaft, drives the compressor wheel arranged in the compressor housing. The exhaust gas exits the turbine housing 7 again through the exhaust-gas outlet duct 4, which is connected to the catalytic converter of the motor vehicle. To regulate the power of the turbine wheel, a wastegate is integrated into the turbine housing. Said wastegate has a wastegate flap which, by means of the electric wastegate actuator integrated into the compressor housing, can be opened to a greater or lesser extent in accordance with the present demand in order to conduct a desired proportion of the hot exhaust gas past the turbine wheel and directly to the exhaust-gas outlet duct.

FIG. 2 shows a perspective sketch of the compressor housing 5 with integrated electric wastegate actuator 8 as an assembly, wherein, in said sketch, the plastics cover 12 has been removed.

It can be seen from FIG. 2 that the electric wastegate actuator 8 has a direct-current motor 13 which is provided with a motor drive output shaft 13a. A drive output gearwheel 14 of the direct-current motor is connected to said motor drive output shaft 13a.

Said drive output gearwheel 14 of the direct-current motor 13 acts, via an intermediate gearwheel 15, on a drive input gearwheel 16 which is connected to a drive output shaft 18 of the electric wastegate actuator. The drive output shaft 18 of the electric wastegate actuator acts on the drive output lever 9 which, via the coupling rod 10 shown in FIG. 1 and the wastegate lever 11, adjusts the wastegate flap as required. FIG. 2 also shows the fresh-air inlet duct 1 and the fresh-air outlet duct 2.

In the device shown in FIG. 2, the torque of the drive output gearwheel 14 of the direct-current motor 13 is transmitted to the intermediate gearwheel 15. The latter in turn transmits the rotary movement to the drive input gearwheel 16 of the drive output shaft 18 of the electric wastegate actuator. The drive output shaft 18 finally acts, via the drive output lever 9, the coupling rod 10 and the wastegate lever 11, on the wastegate flap arranged in the turbine housing 7.

As an alternative to the two-stage gearing described on the basis of FIG. 2, an electric wastegate actuator integrated into the compressor housing may also have one, three, four or even more gearing stages.

FIG. 3 shows a cross-sectional illustration of the compressor housing 5 with integrated electric wastegate actuator. Shown in the middle of said illustration is the fresh-air inlet duct 1 through which the inducted fresh air flows to the compressor wheel. In FIG. 3, the direct-current motor 13 of the electric wastegate actuator is positioned on the right, adjacent to the fresh-air inlet duct 1. The drive output shaft 18 of the electric wastegate actuator is positioned on the side of the fresh-air inlet duct 1 opposite the direct-current motor 13.

It can also be seen from FIG. 3 that the direct-current motor 13 has a drive output shaft 13a to which the drive output gearwheel 14 of the direct-current motor 13 is fastened. Said drive output gearwheel 14 acts, via the intermediate gearwheel 15, on the drive input gearwheel 16 which is fastened to the drive output shaft 18 of the electric wastegate actuator. The drive output shaft 18 of the electric wastegate actuator is rotatably mounted in a rolling bearing 19 and actuates the drive output lever 9. A torsion spring 17 assists the rotary movement during a closing of the wastegate flap.

The arrangement of the components of the electric wastegate actuator is such that all of the parts involved in the transmission of forces and torques are mounted directly on the compressor housing 5. To realize this with a minimum space requirement and in order to attain good thermal coupling to the fresh-air inlet duct 1, the direct-current motor 13, the gearing 14, 15, 16 and the drive output shaft 18 of the electric wastegate actuator are positioned in a U-shaped manner around the fresh-air inlet duct 1. Here, the drive output shaft 18, which in FIG. 3 is illustrated to the left of the fresh-air inlet duct 1, runs through almost the entire compressor housing to the drive output lever 9, such that the length l of the drive output shaft 18 is greater than the diameter d of the fresh-air inlet duct 1.

1-10. (canceled)

11. An exhaust-gas turbocharger, comprising:
a compressor housing formed with a fresh-air inlet duct; and
an electric wastegate actuator integrated into said compressor housing, said electric wastegate actuator being disposed to be thermally coupled to said fresh-air inlet duct.

12. The exhaust-gas turbocharger according to claim 11, wherein said electric wastegate actuator has components disposed to adjoin said fresh-air inlet duct.

13. The exhaust-gas turbocharger according to claim 12, wherein said components of said electric wastegate actuator surround said fresh-air inlet duct in a U-shape.

14. The exhaust-gas turbocharger according to claim 13, wherein said components of said electric wastegate actuator include a direct-current motor, a gearing and a drive output shaft.

15. The exhaust-gas turbocharger according to claim 14, wherein said gearing has a drive output gearwheel connected to said direct-current motor and a drive input gearwheel connected to said drive output shaft and coupled to said drive output gearwheel.

16. The exhaust-gas turbocharger according to claim 15, which comprises an intermediate gearwheel coupling said drive input gearwheel of said drive output shaft to said drive output gearwheel of said direct-current motor.

17. The exhaust-gas turbocharger according to claim 14, which comprises a roller bearing and said drive output shaft is mounted in said roller bearing.

18. The exhaust-gas turbocharger according to claim 14, wherein said drive output shaft is disposed to act on a drive output lever.

19. The exhaust-gas turbocharger according to claim 14, wherein said direct-current motor and said drive output shaft are arranged on mutually opposite sides of said fresh-air inlet duct.

20. The exhaust-gas turbocharger according to claim 14, wherein a length of said drive output shaft is greater than a diameter of said fresh-air inlet duct.
